(19) United States
(12) Patent Application Publication
(10) Pub. No.: US 2025/0234809 A1
(43) Pub. Date: Jul. 24, 2025

(54) Cotton harvester with continuous baling and a method for harvesting cotton

(71) Applicant: McHale Engineering, Ballinrobe (IE)

(72) Inventor: Kenneth R. Underhill, Strasburg, PA (US)

(73) Assignee: McHale Engineering, Ballinrobe, (IE)

(21) Appl. No.: 19/029,978

(22) Filed: Jan. 17, 2025

Related U.S. Application Data
(60) Provisional application No. 63/622,697, filed on Jan. 19, 2024.

(51) Int. Cl. A01D 46/12; A01F 15/08

(52) U.S. Cl. CPC A01D 46/12; A01F 15/08

(57) ABSTRACT

A cotton harvester for harvesting and baling cotton bolls into a cylindrical bale comprises a cotton picker/stripper for stripping cotton bolls from cotton plants, and a continuous round baler for compressing, rotating and forming the cotton bolls into a round bale cylinder from which round bales are severed. The baler comprises a conical bale chamber and a cylindrical bale chamber. The cotton bolls are continuously blown through the conduit from the picker/stripper into the conical bale chamber and a forward part of the cylindrical bale chamber through a roll gap between spaced apart pairs of frustoconical rolls and cylindrical rolls, forming the conical and cylindrical bale chambers, and the compressed rotating round bale cylinder of cotton bolls protrudes axially through the cylindrical bale chamber. Prior to exiting the cylindrical bale chamber the rotating round bale cylinder is circumferentially wrapped with wrapping material.

### CROSS REFERENCE TO RELATED APPLICATIONS

This application claims priority on Irish Full-Term Patent Application No. 2024/0102, filed on Feb. 22, 2024, and claims domestic priority on U.S. Provisional Patent Application Ser. No. 63/622,697, filed on Jan. 19, 2024, the contents of which are incorporated herein by reference.

### FIELD OF INVENTION

This application relates generally to agricultural machines for harvesting cotton and, more particularly, to cotton harvesting machines that incorporate a baling apparatus to receive the harvested cotton bolls and create a round bale that is ejected from the machine for placement in the field and subsequent retrieval.

### BACKGROUND OF THE INVENTION

Cotton harvesters have been in use to harvest cotton bolls from ripened cotton plants for many decades. These agricultural machines pick or strip the cotton bolls from the plant and convey the bolls with air generated by a fan carried by the cotton harvester into a receiving apparatus. Traditionally, the cotton harvester carried a large storage bin on the frame of the harvester behind the apparatus for picking or stripping the cotton bolls from the cotton plants. The storage bin would become packed with harvested cotton bolls and then the cotton harvester would stop and either eject the unwrapped and slightly packed cotton from the storage bin to the ground, or unload the storage bin into a separate wagon for transport from the field.

The combination of a cotton harvester having an onboard round baler apparatus was the subject of patents owned by Deere & Company, as can be seen in U.S. Pat. No. 6,263,650, granted to Timothy A. Deutsch, et al on Jul. 24, 2001, and in U.S. Pat. No. 9,345, 196, granted to Scott D. Weber on May 24, 2016, as well as many other related patents. Essentially, the round baler apparatus requires a certain length of time to cease receiving material to be incorporated into the formed round bale, wrap netting material around the bale and discharge the wrapped round bale from the baling apparatus. To accommodate this time lapse in baling operations, the cotton harvester must also incorporate an accumulation chamber so that harvested cotton bolls can be stored while the round baler apparatus is wrapping and discharging the formed round bale. Once the bale has been discharged and the tailgate closed, the round baler apparatus can receive accumulated cotton bolls from the accumulation chamber to start forming another round bale.

It would be desirable to provide a cotton harvester with a continuous round baler that receives the harvested cotton bolls directly from the cotton harvesting process without requiring accumulation while the round baler apparatus is wrapping and discharging the formed bale.

The present invention is directed towards such a cotton harvester and is also directed towards a method for harvesting cotton bolls from standing cotton plants.

### SUMMARY OF THE INVENTION

According to the invention there is provided a cotton harvester for harvesting cotton bolls from standing cotton plants, comprising:
a frame;
a conduit cooperable with a fan to provide an air flow through said conduit to convey harvested cotton bolls rearwardly; and
a continuous round baler supported on said frame and operable to receive harvested cotton bolls from said conduit and to continuously form a round bale cylinder protruding rearwardly from said round baler, said continuous round baler including a severance mechanism to sever a round bale of selected length from said protruding round bale cylinder for discharge to the ground.

Preferably, said continuous round baler includes a conical bale chamber and a rearwardly adjacent cylindrical bale chamber. Advantageously, the cylindrical bale chamber extends from a forward end adjacent the conical bale chamber to a rearward end thereof facing in a direction rearwardly of the normal forward direction of movement of the harvester. Preferably, the conical bale chamber diverges to a rearward end thereof adjacent the forward end of the cylindrical bale chamber, and preferably, the conical bale chamber communicates with the cylindrical bale chamber through the rearward end of the conical bale chamber.

In one embodiment of the invention the conical bale chamber and the cylindrical bale chamber are axially aligned.

In another embodiment of the invention the conical bale chamber and the cylindrical bale chamber define a common central axis, the common central axis defined by the conical bale chamber and the cylindrical bale chamber lying in a plane substantially parallel to the normal forward direction of movement of the harvester.

Preferably, the conical bale chamber is defined by a plurality of circumferentially arranged frustoconical bale rotating rolls, and the cylindrical bale chamber is defined by a plurality of circumferentially arranged parallel cylindrical bale rotating rolls.

Preferably, said conduit delivers said cotton bolls into said continuous round baler through a roll gap formed between the bale rotating rolls.

Preferably, said conical bale chamber forms a conical bale that protrudes into said cylindrical bale chamber.

In another embodiment of the invention said conduit delivers cotton bolls to both said conical bale chamber having a first maximum diameter and said cylindrical bale chamber having a second diameter greater than said first maximum diameter, said conical bale chamber protruding said conical bale rearwardly into said cylindrical bale chamber where said cotton bolls delivered to said cylindrical bale chamber adds a laminar layer onto said conical bale to increase the diameter of said bale to said second diameter.

Preferably, the cotton bolls delivered to said cylindrical bale chamber are delivered to the cylindrical bale chamber towards the forward end of the cylindrical bale chamber.

In another embodiment of the invention the cotton harvester further comprises a telescoping tailgate engageable with a distal end of said round bale cylinder protruding from said cylindrical bale chamber.

In one embodiment of the invention the tailgate comprises a bale engaging disc for engaging the distal end of the protruding round bale cylinder protruding from the cylindrical bale chamber, and preferably, the bale engaging disc is rotatably mounted on the tailgate, and advantageously, the bale engaging disc is adapted to rotate with the protruding round bale cylinder.

In another embodiment of the invention the tailgate extends from an inner telescoping member slideable within an outer telescoping member, and preferably, the outer telescoping member is rigidly connected to the frame. Preferably, the inner telescoping member is slideable outwardly of the outer telescoping member to accommodate movement of the tailgate with the continuously protruding round bale cylinder continuously protruding from the rearward end of the cylindrical bale chamber.

In another embodiment of the invention the inner telescoping member is slideable outwardly relative to the outer telescoping member against an urging force urging the inner telescoping member inwardly into the outer telescoping member. Advantageously, the inner telescoping member is urged outwardly of the outer telescoping member in response to engagement of the distal end of the round bale cylinder with the tailgate as the round bale cylinder continuously protrudes from the rearward end of the cylindrical bale chamber.

Preferably, the telescoping tailgate is moveable with the distal end of the round bale cylinder to control and/or to adjust the density of the round bale cylinder.

Preferably, said telescoping tailgate disengages from said round bale after said round bale is severed from said round bale cylinder, the tailgate being retracted and repositioned to engage a new distal end of said round bale cylinder protruding from said cylindrical bale chamber in response to severing of the round bale from the round bale cylinder.

In another embodiment of the invention the tailgate is coupled to the inner telescoping member to accommodate movement of the tailgate between an operative state engaging the distal end of the continuously protruding round bale cylinder extending from the rearward end of the cylindrical bale chamber and an inoperative state disengaged from the distal end of the continuously protruding round bale cylinder for releasing a round bale severed from the round bale cylinder.

In another embodiment of the invention the severance mechanism is latched relative to the telescoping tailgate in response to the round bale cylinder protruding from the cylindrical bale chamber being of length substantially equal to the selected length of the round bale to move synchronously with the tailgate during severing of the round bale cylinder.

Advantageously, the severance mechanism is latchable relative to the tailgate for moving synchronously with the tailgate during severing of the round bale cylinder in response to the protruding round bale cylinder between the tailgate and the severance mechanism being of the selected length.

Advantageously, the severance mechanism is free to move relative to the tailgate in a direction parallel to the protruding round bale cylinder when the severance mechanism is unlatched relative to the tailgate.

Preferably, the severance mechanism is latchable onto the inner telescoping member of the telescoping mounting of the tailgate, and preferably, the severance mechanism is slideable along the inner telescoping member relative to the tailgate when the severance mechanism is unlatched from the inner telescoping member.

In one embodiment of the invention the severance mechanism comprises at least one knife operable between an inactive state and a cutting state for cutting through at least a part of the bale, and preferably, the severance mechanism comprises a pair of knives operable between respective inactive states and cutting states. Preferably, each knife is of length sufficient to cut into the round bale cylinder to a central portion thereof.

Preferably, an operating means is provided for operating each cutting knife between the inactive state and the cutting state for severing a bale from the round bale cylinder.

In another embodiment of the invention the cotton harvester further comprises a cotton picker/stripper supported from a forward position on said frame to harvest cotton bolls from standing cotton plants, said conduit delivering said cotton bolls from said cotton picker/stripper to said continuous round baler.

Preferably, the fan is located in the cotton picker/stripper or in the conduit or between the cotton picker/stripper and the conduit for producing the flow of air through the conduit for conveying the cotton bolls through the conduit from the cotton picker/stripper to the round baler.

Preferably, said conduit includes flow control baffles to deflect cotton bolls into the conical and cylindrical bale chambers and screening to allow air to escape said conduit to lower pressure and assist the direction of the cotton bolls into the conical and cylindrical bale chambers.

Preferable, the cotton harvester further comprises a wrapping system positioned at a rearward portion of said cylindrical bale chamber to place a wrapping material on an outer circumferential surface of said round bale cylinder.

Preferably, said wrapping system applies a wrapping material that presents a non-tacky surface against said outer circumferential surface of said round bale cylinder and a tacky surface facing outwardly from said round bale cylinder so that progressive overlapping turns of said wrapping material stick together as the wrapping material is applied to the continuously protruding round bale cylinder.

Alternatively, the wrapping system comprises applying a first wrapping material against said outer circumferential surface of said round bale cylinder, the first wrapping material comprising respective opposite non-tacky surfaces, and applying a second wrapping material over said first wrapping material, said second wrapping material having a tacky surface, and an opposite non-tacky surface, and the second wrapping material being applied over the first wrapping material with the tacky surface of the second wrapping material engaging the first wrapping material for securing the second wrapping material to the first wrapping material, and in turn for retaining the first wrapping material in place against the outer circumferential surface of the round bale cylinder.

Preferably, the first wrapping material is initially applied to the round bale cylinder, and the second wrapping material is then applied over the first wrapping material.

In one embodiment of the invention the first and second wrapping materials are entered into the cylindrical bale chamber between an adjacent pair of the cylindrical bale rotating rolls, and in an alternative embodiment of the invention the first and second wrapping materials are entered into the cylindrical bale chamber between respective adjacent pairs of cylindrical bale rotating rolls, and preferably, when the first and second wrapping materials are being entered into the cylindrical bale chamber through respective adjacent pairs of cylindrical bale rotating rolls, the first wrapping material is entered between one of the cylindrical bale rotating rolls and one of its adjacent cylindrical bale rotating rolls, and the second wrapping material is entered into the cylindrical bale chamber through the said one cylindrical bale rotating roll and the other one of its adjacent cylindrical bale rotating rolls.

Preferably, the first and second wrapping materials comprise film wrapping materials, and advantageously, the first and second wrapping materials comprise plastics film wrapping materials.

Additionally, the invention provides a combination cotton harvester and round baler for harvesting cotton bolls from standing cotton plants and forming round bales of cotton bolls, comprising:
a frame supporting a cotton picker/stripper for removing cotton bolls from standing cotton plants;
a conduit operatively interconnecting said picker/stripper and being co-operable with a fan to provide an air flow through said conduit to convey harvested cotton bolls rearwardly from said picker/stripper; and
a continuous round baler supported on said frame and operable to receive harvested cotton bolls from said conduit and to continuously form a round bale cylinder protruding rearwardly from said round baler, said continuous round baler including a severance mechanism to sever a round bale of selected length from said protruding round bale cylinder for discharge to the ground, said continuous round baler also including a conical bale chamber formed by a plurality of conical bale rotating rolls terminating at a cylindrical bale chamber to form said round bale cylinder axially protruding rearwardly from said cylindrical bale chamber.

Preferably, said continuous round baler includes a tailgate engaged with a rearward end of said round bale cylinder protruding rearwardly, said tailgate helping to control density in said round bale cylinder.

Advantageously, each said conical bale rotating roll includes a taper having a predetermined slope value, said predetermined slope value and said tailgate controlling density of said round bale cylinder.

The invention also provides a method for harvesting cotton bolls from standing cotton plants, the method comprising:
conveying cotton bolls harvested from the standing plants through a rearwardly extending conduit in an air flow through the conduit to a continuous round baler,
continuously forming a round bale cylinder in the continuous round baler and protruding the round bale cylinder rearwardly from the continuous round baler, and
severing a round bale of selected length from the protruding round bale cylinder.

Preferably, the continuous round baler comprises a conical bale chamber and a rearwardly adjacent cylindrical bale chamber communicating with the conical bale chamber, and the method further comprises conveying the cotton bolls into the conical bale chamber, and forming a conical bale of the cotton bolls in the conical bale chamber, and protruding the conical bale into the cylindrical bale chamber to form a round bale cylinder.

Advantageously, cotton bolls are delivered into the cylindrical bale chamber towards a forward end thereof to form a laminar layer extending circumferentially around the round bale cylinder in the cylindrical bale chamber.

### Advantages of the Invention

The advantages of the cotton harvester according to the invention are many. A major advantage of the cotton harvester is that the cotton harvester continuously produces round bales without the requirement of a cotton accumulation chamber. The cotton bolls are delivered directly to the continuous round baler for continuous baling, thereby eliminating the need for accumulating crop while the continuous round baler wraps and discharges the round bale. The continuous axially protruding round bale forming and wrapping system of the cotton harvester according to the invention is simpler and more compact than the existing conventional systems of conventional balers, thereby, making the cotton harvester according to the invention a lower cost harvester to manufacture, market and maintain. The bale wrapping system of the cotton harvester according to the invention presents a less complicated apparatus for wrapping the formed round bale than is presently known. The bale wrapping system does not require starting or cutting with each bale formed, and bales are always wrapped to the bale edge.

The bale chambers of the continuous round baler have a natural advantage to produce extremely dense bales, which have greater density than bales produced by current cotton harvesters. Current round baler apparatus on cotton harvesters produce a large diameter round baler, typically of approximately 2 metres in diameter. The conical bale chamber produces a dense conical bale which protrudes into the cylindrical bale chamber, thereby producing a dense core, onto which the dense laminar layer of the cotton bolls is wrapped around the dense core to form a dense round bale cylinder from which the round bale is severed. Density of the core of the round bale cylinder may be increased by increasing the slope angle of the common central axis defined by the conical and cylindrical bale chambers, which results in a slower protrusion rate of the conical bale from the conical bale chamber into the cylindrical bale chamber. Furthermore, the density of the round bale cylinder may be adjusted by appropriately varying the urging force that urges the inner telescoping member into the outer telescoping member which in turn urges the tailgate into engagement with the distal end of the round bale cylinder continuously protruding from the rearward end of the cylindrical bale chamber. By varying the urging force urging the inner telescoping member into the outer telescoping member, the rate at which the round bale cylinder protrudes from the cylindrical bale chamber is varied, thereby varying the density of the round bale cylinder. By increasing the urging force urging the inner telescoping member into the outer telescoping member, the density of the round bale cylinder is increased, and in turn the density of the severed round bale is increased, and vice-versa by reducing the urging force. The bale formation function of the continuous round baler is simpler and the continuous round baler is smaller in size than current round balers, making the cotton harvester with the incorporated continuous round baler a lower cost machine to manufacture and market.

### BRIEF DESCRIPTION OF THE DRAWINGS

The invention and the advantages thereof will become apparent upon consideration of the following detailed disclosure of a preferred embodiment of the invention which is provided solely by way of example only with reference to the accompanying drawings wherein:

FIG. 1 is a schematic side elevational view of cotton harvester according to the invention having a conduit for blowing harvested cotton bolls directly into a continuous round baler operable to protrude a circumferentially wrapped round bale rearwardly;

FIG. 2 is a schematic side elevational view of the cotton harvester of FIG. 1 but having air flow control baffles mounted in the upper surface of the conduit;

FIG. 3 is a schematic front perspective view of the continuous round baler of the cotton harvester, the dashed lines and arrows being indicative of the path of the delivery of harvested cotton bolls through the conduit directly into a conical bale chamber and a cylindrical bale chamber of the continuous round baler;

FIG. 4 is a schematic side elevational view of the cotton harvester depicting the continuous operation of the round baler to protrude rearwardly a wrapped cylinder of compressed harvested cotton bolls;

FIG. 5 is a schematic side elevational view of the cotton harvester depicting the severance of a length of the rearwardly protruding cylinder of compressed harvested cotton bolls to create a round bale of cotton bolls deposited on the ground rearwardly of the cotton harvester;

FIG. 6 is a rear perspective view of a portion of the cotton harvester of FIG. 1;

FIG. 7 is a rear end elevational view of a detail of the portion of the cotton harvester of FIG. 1;

FIG. 8 is a view similar to FIG. 7 of the detail of FIG. 7 illustrating the detail of FIG. 7 in a different state to that of FIG. 7; and

FIG. 9 is an underneath perspective view of another portion of the cotton harvester of FIG. 1.

### DETAILED DESCRIPTION OF THE PREFERRED EMBODIMENT

Referring to the drawings, the structure of a cotton harvester according to the invention indicated generally by the reference numeral 10 is illustrated. The cotton harvester 10 comprises a continuous round baler 20 supported on the rearward portion of a frame 11 of the cotton harvester 10 and a cotton picker/stripper 12 supported at the forward portion of the frame 11 to pick and strip cotton bolls 7 off the cotton plants 8. The separated cotton bolls 7 are then blown rearwardly and upwardly from the cotton picker/stripper 12 by an air flow through a conduit 15 extending between an upstream end 13 and a downstream end 14, and the cotton bolls 7 are delivered into the continuous round baler 20, as will be described in detail below. The continuous round baler 20 is operable to receive the harvested cotton bolls 7 from the conduit 15 adjacent the downstream end 14 thereof, and to create a rearwardly protruding round bale cylinder 26 of compressed cotton bolls wrapped in a wrapping material, as will be described in greater detail below, from which circumferentially wrapped round bales 16 of the compressed cotton bolls are severed, as will also be described below. The cotton picker/stripper 12 is a conventional cotton picker/stripper and will be well known to those skilled in the art.

In this embodiment of the invention the cotton harvester 10 is a self propelled harvester comprising its own power unit (not shown), which may be an internal combustion engine, or one or more battery powered electric motors, which power ground engaging wheels 17 rotatably carried on the frame 11. A driver's cab 18 mounted on the forward end of the frame 11 accommodates a driver for driving the cotton harvester 10. A suitable pressurised hydraulic system (not shown) powered by the internal combustion engine or the battery powered electric motor or motors is also provided to operated hydraulically operated components of the cotton harvester as will be understood by those skilled in the art. Additionally, suitable mechanical drive transmission systems (also not shown), such as drive transmission chains, belts and/or gearing are provided for operating the continuous round baler 20 as will also be understood by those skilled in the art. A suitable control system (not shown) as will be well known to those skilled in the art is also provided for controlling the operation of the cotton picker/stripper 12, the continuous round baler 20 and other components of the cotton harvester 10. However, it will be appreciated that in some embodiments of the invention the cotton harvester 10 may be provided to be towed by a tractor and powered by the power take-off shaft of the towing tractor, and also to be powered by the hydraulic and electrical system of the tractor.

Turning now to the continuous round baler 20, the continuous round baler 20 comprises a conical bale chamber 22 and a cylindrical bale chamber 24 located rearwardly of and axially aligned with the conical bale chamber 22, both of which are substantially similar to the conical bale chamber and the cylindrical bale chamber of the continuous round balers described in the applicant's co-pending U.S. patent application Ser. No. 17/765,648, filed on Mar. 31, 2022, and accorded a filing date of Oct. 2, 2020 from the applicant's PCT Application No. PCT/EP 2020/077748, (Publication No. 2021/064224).

The conical bale chamber 22 is defined by a plurality of circumferentially arranged frustoconical bale rotating rolls 21 and extends from a forward end 27 to a rearward end 28. The cylindrical bale chamber 24 is defined by a plurality of circumferentially arranged parallel cylindrical bale rotating rolls 23 and extends from a forward end 29 adjacent the rearward end 28 of the conical bale chamber 22 to a rearward end 30. The conical bale chamber 22 and the cylindrical bale chamber 24 are axially aligned and define a common central axis 32, which inclines slightly rearwardly upwardly relative to the horizontal, and which lies in a plane parallel to the direction of normal forward motion of the cotton harvester 10.

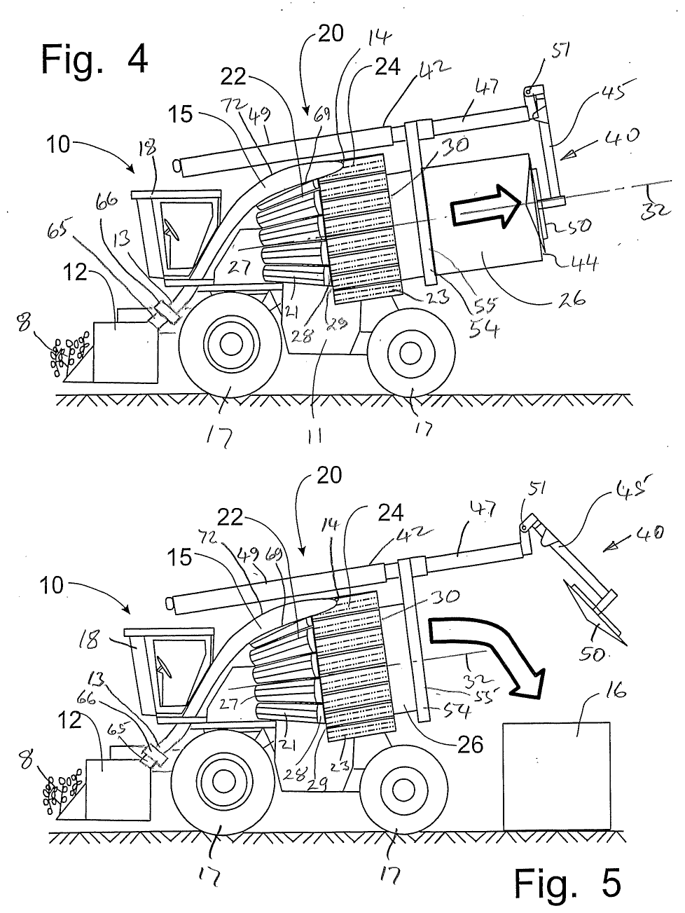

The frustoconical bale rotating rolls 21 and the cylindrical bale rotating rolls 23 are driven in rotation in the direction of the arrows A, for in turn rotating the harvested cotton bolls in the conical and cylindrical bale chambers 22 and 24 in the direction of the arrow B. As the harvested cotton bolls are continuously delivered into the conical bale chamber 22, the cotton bolls are compressed into a conical bale 33 rotating in the direction of the arrow B in the conical bale chamber 22. The rotating conical bale 33 progressively protrudes into the cylindrical bale chamber 24 to form the rotating round bale cylinder 26 which continuously and progressively protrudes rearwardly from the cylindrical bale chamber 24 at the rearward end 30 thereof, as depicted in FIG. 4. The protruding rotating round bale cylinder 26 when it is of the selected length to form a round bale 16, is then severed to form the round bale 16, see FIG. 5.

The cotton bolls 7 are delivered in the direction of the arrows C from the cotton picker/stripper 12 through the conduit 15 into the conical bale chamber 22 and also into a forward portion of the cylindrical bale chamber 24 towards the forward end 29 thereof through a roll gap 25. The roll gap 25 is formed between a pair of the frustoconical bale rotating rolls 21 of the conical bale chamber 22 and is formed between a pair of the cylindrical bale rotating rolls 23 of the cylindrical bale chamber 24. In this embodiment of the invention the roll gap 25 is located adjacent the upper portion of the conical and cylindrical bale chambers 22 and 24. The harvested cotton bolls 7 are rotated and compressed in the conical bale chamber 22 to form the rotating conical bale 33. As harvested cotton bolls are continuously fed into the conical bale chamber 22, the rotating conical bale 33 continuously and progressively protrudes into the cylindrical bale chamber 24. The exit diameter of the conical bale chamber 22 which is the diameter thereof adjacent the rearward end 28 of the conical bale chamber 22, is the maximum diameter of the conical bale chamber 22. This maximum diameter of the conical bale chamber 22 is smaller than the diameter of the cylindrical bale chamber 24. The addition of the harvested cotton bolls to the cylindrical bale chamber 24 adjacent the forward portion thereof, increases the diameter of the rotating protruding bale from the conical bale chamber 22 with a laminar layer 34 of harvested cotton bolls on top of the conical layering created by the conical bale chamber 22.

As harvested cotton bolls are added to the conical bale chamber 22 and to the forward portion of the cylindrical bale chamber 24, the rotating round bale cylinder 26 continuously progresses through the cylindrical bale chamber 24 to the rearward end thereof, and continuously and progressively protrudes from the rearward end 30 of the cylindrical bale chamber 24.

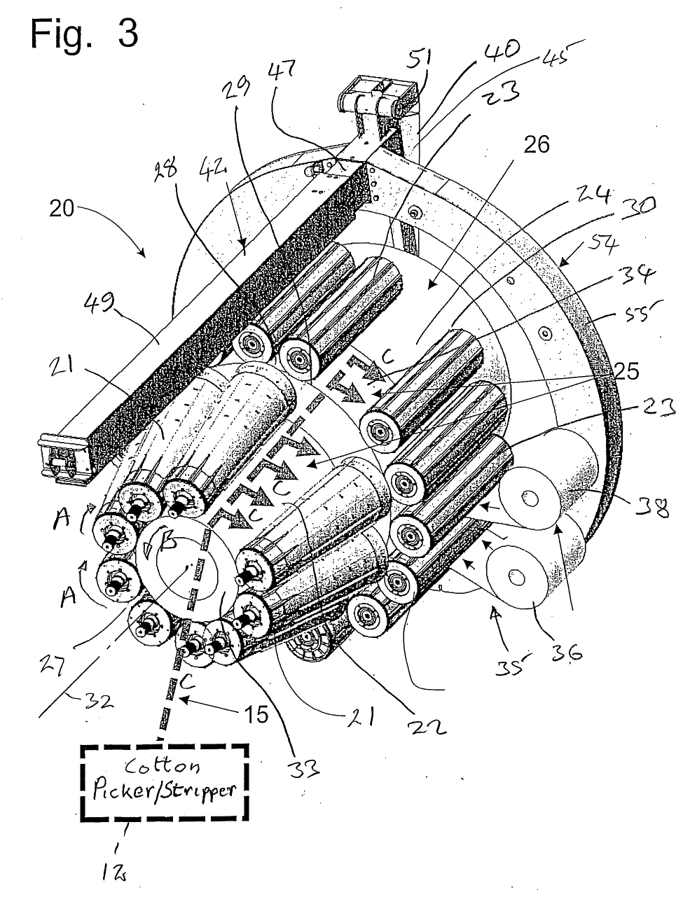

As the rotating protruding round bale cylinder 26 reaches the rearward portion of the cylindrical bale chamber 24, a wrap material is applied to the outer circumferential surface of the round bale cylinder prior to the rotating round bale cylinder 26 protruding from the rearward end 30 of the cylindrical bale chamber 24 as is depicted in FIG. 3. The wrapping material applied to the outer circumferential surface of the rotating round bale cylinder 26 may be a simple netting material provided that the mesh of the netting material is sufficiently small as to retain the compression of the round bale cylinder 26 without losing cotton bolls from the round bale cylinder. This small mesh netting material is a departure from the standard wrapping material currently applied to baled cotton, but would be an effective wrapping material because of the continuous placement of the wrapping material as the round bale cylinder 26 is rotating in the cylindrical bale chamber 24, creating overlapping of the net wrapping material. No starting or cutting of the wrapping material is required and the round bales are always circumferentially wrapped to the end edges of the bale.

FIG. 3 depicts an alternative wrapping system 35 to both the current conventional complex and also to the small mesh net wrapping material identified above. Two solid, non-mesh, film wrapping materials may be applied to be similar to the current cotton bale wrapping by placing a first film wrapping material from a first roll 36 thereof next to the circumferential surface of the rotating round bale cylinder 26 with adjacent turns thereof partly overlapping, and then placing a second film wrapping material from a second roll 38 thereof over the top of the first film wrapping material with adjacent turns thereof partly overlapping. The first film wrapping material comprises a plastics film wrapping material with respective non-tacky opposite surfaces, and the second film wrapping material comprises a plastics film wrapping material with a tacky surface and an opposite non-tacky surface. The second film wrapping material is applied over the first film wrapping material with the tacky surface thereof engaging the first film wrapping material for securing the second film wrapping material to the first film wrapping material, for in turn securing the first film wrapping material to the round bale cylinder 26.

As the adjacent turns of the non-tacky first film wrapping material from the first roll 36 partly overlap with each other on the rotating round bale cylinder 26, and the adjacent turns of the second film wrapping material from the second roll 38 partly overlap with each other, the overlapping parts of the second film wrapping material stick to each other, and the tacky surface of the turns of the second film wrapping material stick to the overlapping turns of the non-tacky first film wrapping material, the rotating round bale cylinder 26 is circumferentially wrapped with the non-tacky first film wrapping material and the second film wrapping materials, with the underlying non-tacky first film wrapping material from the first roll 36 thereof presenting a non-tacky surface against the outer circumferential surface of the rotating round bale cylinder 26, and with the non-tacky surface of the second film wrapping material presenting a non-tacky outer surface of the wrapped round bale cylinder 26, so that the round bale 16 when severed from the wrapped round bale cylinder 26 presents a non-tacky outer circumferential surface suitable for handling. Since the round bale is wrapped with one of the non-tacky surfaces of the first film wrapping material against the circumferential surface of the bale, the wrapping material may be subsequently removed from the round bale 16 without the risk of the cotton bolls or parts thereof remaining stuck to the wrapping material.

In this embodiment of the invention the first film wrapping material from the first roll 36 is fed into the cylindrical bale chamber 24 between a pair of the cylindrical bale rotating rolls 23, in other words, between one of the cylindrical bale rotating rolls, namely, the cylindrical bale rotating roll 23a and one of its adjacent cylindrical bale rotating rolls, namely, the cylindrical bale rotating roll 23b, and the second film wrapping material is fed from the second roll 38 into the cylindrical bale chamber 24 between the cylindrical bale rotating roll 23a and its other adjacent cylindrical bale rotating roll, namely, the cylindrical bale rotating roll 23c. However, it is envisaged that the first and second film wrapping materials from the respective first and second rolls 36 and 38 thereof, may be fed into the cylindrical bale chamber 24 between the same pair of cylindrical bale rotating rolls 23. Alternatively, it is envisaged that the first and second film wrapping materials from the respective first and second rolls 36 and 38 thereof, may be fed into the cylindrical bale chamber between different pairs of cylindrical bale rotating rolls 23. In other words, in which case there may be one or more cylindrical bale rotating rolls between the adjacent pairs of cylindrical bale rotating rolls between which the first and second film wrapping materials from the respective first and second rolls 36 and 38 thereof may be entered into the cylindrical bale chamber 24.

Alternatively, by providing a film wrapping material that is non-tacky on the side that contacts the rotating round bale cylinder 26, and tacky on the opposite side to stick the overlapping turns of the film wrapping material together to hold the bale together, only a single layer of overlapping wrapping material needs to be applied.

The film wrapping material or materials typically are of a plastics film material of approximately 350 mm wide and is/are constantly/continuously applied to the circumferential surface of the rotating round bale cylinder 26 just prior to the round bale cylinder 26 passing through the rearward portion end 30 of the cylindrical bale chamber 24. Since the bale wrapping material is only approximately 350 mm wide, and is constantly/continuously applied to the rotating round bale cylinder 26, the process does not incur a wrap tail to cause problems with not sticking.

A tailgate 40, which is mounted on the frame 11 by a telescoping mounting 42 engages a distal end 44 of the rotating round bale cylinder 26 as the rotating round bale cylinder 26 protrudes rearwardly from the rearward end 30 of the cylindrical bale chamber 24 for supporting the protruding round bale cylinder 26 and for controlling and adjusting the density thereof. The tailgate 40 comprises a carrier member 45 extending downwardly from an inner telescoping member 47 which is slideably mounted in an outer telescoping member 49 of the telescoping mounting 42. The outer telescoping member 49 is rigidly secured to the frame 11. The carrier member 45 of the tailgate 40 rotatable carries a bale engaging disc 50 which engages and supports the distal end 44 of the rotating round bale cylinder 26 and rotates therewith.

Outward movement of the inner telescoping member 47 from the outer telescoping member 49 of the telescoping mounting 42 is controlled by a density control mechanism, which controls the pressure applied by the bale engaging disc 50 to the distal end 44 of the rotating round bale cylinder 26, in order to control the density of the round bale cylinder 26. The density control mechanism may comprise a hydraulic, pneumatic or spring control system acting between the inner and outer telescoping members 47 and 49 for controlling the force required to be applied by the distal end 44 of the rotating round bale cylinder 26 to the bale engaging disc 50 of the tailgate 40 to urge the tailgate 40 outwardly from the rearward end 30 of the cylindrical bale chamber 24 as described in the applicant's co-pending U.S. patent application Ser. No. 17/765,648. The greater the force required to be applied to the tailgate 40 by the rotating round bale cylinder 26, the greater will be the density of the rotating round bale cylinder 26.

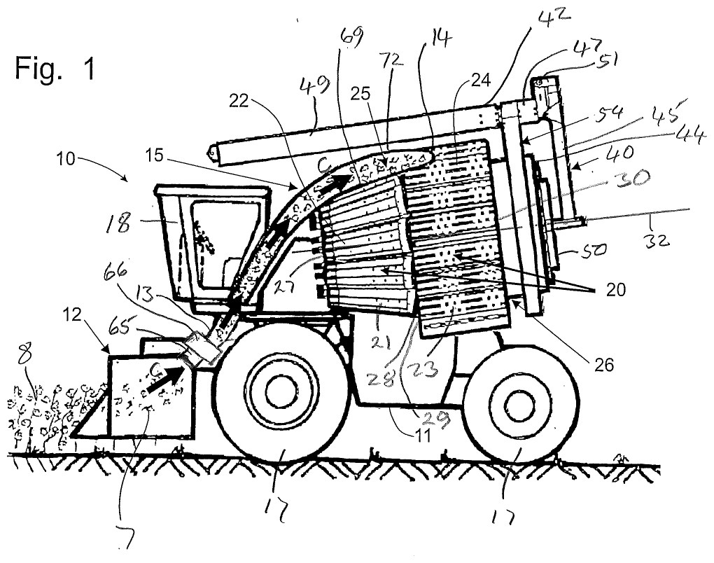

The carrier member 45 of the tailgate 40 is pivotally coupled to the inner telescoping member 47 by a pivot pin 51 and is pivotal from an operative state illustrated in FIGS. 1, 2 and 4 with the bale engaging disc 50 of the tailgate 40 engaging and supporting the distal end 44 of the rotating round bale cylinder 26, and an inoperative state illustrated in FIGS. 5 and 6 with the bale engaging disc 50 disengaged from the distal end 44 of the rotating round bale cylinder 26 to allow a round bale 16 severed from the rotating round bale cylinder 26 to drop to the ground. A hydraulically powered ram (not shown) acting between the inner telescoping member 47 and the carrier member 45 operates the tailgate 40 between the operative state and the inoperative state, and is operated to retain the tailgate 40 in the operative state while the rotating round bale cylinder 26 is progressively protruding from the rearward end 30 of the cylindrical bale chamber 24 until the round bale 16 is severed from the rotating round bale cylinder 26. At which stage, the ram (not shown) operates the tailgate 40 from the operative state to the inoperative state to allow the severed bale 16 to drop to the ground.

When the rotating round bale cylinder 26 has extended sufficiently from the rearward end of the cylindrical bale chamber 24 to form a round bale 16 of the selected length, a severance mechanism 54 is activated to sever the round bale 16 of the selected length from the rotating round bale cylinder 26. The severance mechanism 54 may comprise one or two knives pivotally mounted in a circular severance frame 55, through which the rotating round bale cylinder 26 protrudes, for severing the round bale 16 from the rotating round bale cylinder 26, see FIGS. 6 to 9. In this embodiment of the invention two knives 56 are pivotally mounted in the severance frame 55, as will be described below. The severance frame 55 is slideably carried on the inner telescoping member 47. When the rotating round bale cylinder 26 has protruded from the rearward end 30 of the cylindrical bale chamber 24 a sufficient distance to form the round bale 16 of the selected length, the severance frame 55 of the severance mechanism 54 is latched onto the inner telescoping member 47, so that the severance frame 55 travels with the inner telescoping member 47, and in turn with the protruding rotating round bale cylinder 26, so that the knives 56 sever the round bale 16 from the rotating round bale cylinder 26 with a planar cut transversely across the rotating round bale cylinder 26.

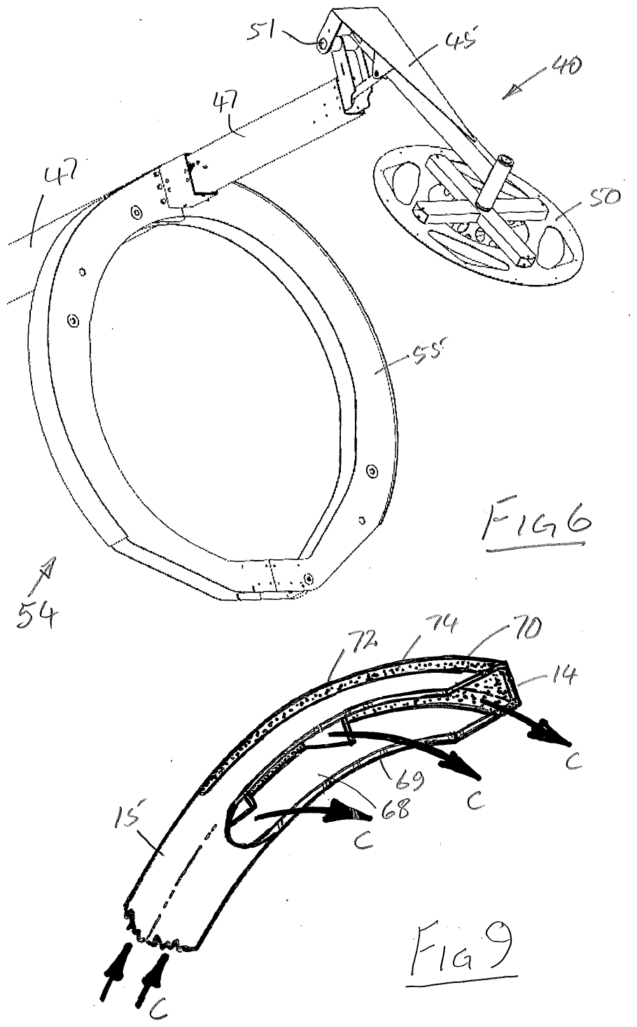

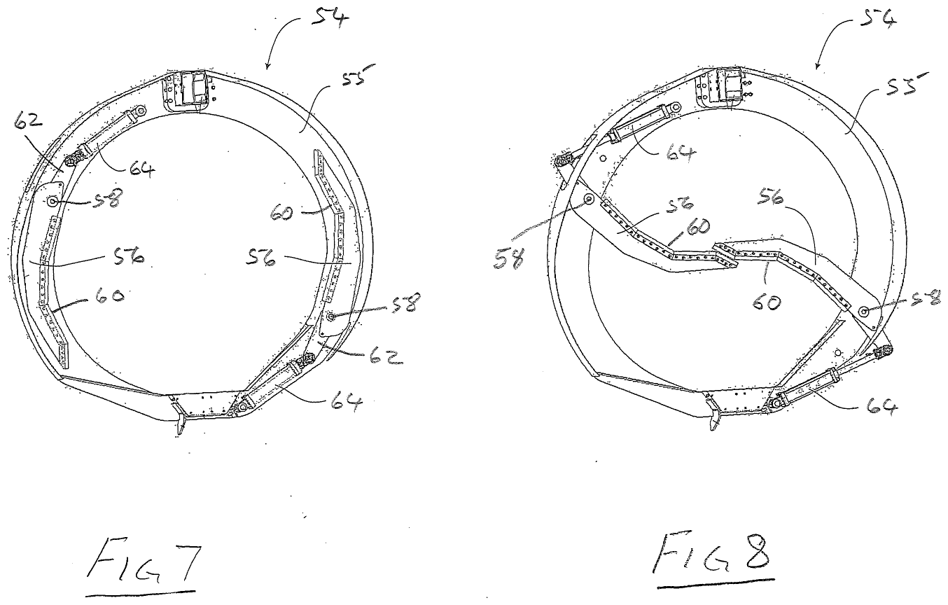

Each knife 56 is pivotally coupled to the severance frame 55 about a corresponding pivot pin 58 and comprises a cutting edge 60. The pivot pins 58 are spaced apart around the severance frame 55 at 180° intervals. Operating arms 62 rigidly secured to the respective knives 56 extend from the knives 56 past the corresponding pivot pins 58 on the opposite side to that of the cutting edges 60, see FIGS. 7 and 8. An operating means, in this case a pair of hydraulic rams 64 acting between the severance frame 55 and the operating arms 62 of the respective knives 56 simultaneously operate the knives 56 between an inactive state illustrated in FIG. 7 located within the severance frame 55 and a cutting state illustrated in FIG. 8 for severing the round bale 16 from the rotating round bale cylinder 26. The knives 56 are of sufficient length so that each knife 56 cuts through just over half the diameter of the rotating round bale cylinder 26.

Once the round bale 16 has been severed from the rotating round bale cylinder 26, the tailgate 40 is pivoted from the operative state to the inoperative state to allow the severed round bale 16 to drop to the ground. The tailgate 40 is then pivoted into the operative state, the severance frame 55 is unlatched from the inner telescoping member 47, and the inner telescoping member 47 is retracted into the outer telescoping member 49, thereby returning the tailgate 40 and the bale severance mechanism 54 to the rearward end 30 of the cylindrical bale chamber 24, so that the bale engaging disc 50 of the tailgate 40 engages the severed end of the rotating round bale cylinder 26 for again supporting and controlling the density of the rotating round bale cylinder 26 and to advance with the rotating round bale cylinder 26 to form the next round bale 16.

Turning now to the delivery of the harvested cotton bolls from the cotton picker/stripper 12 through the conduit 15 to the continuous round baler 20, a fan 66 is located between an outlet port 65 from the cotton picker/stripper 12 and the upstream end 13 of the conduit 15 to produce the airflow through the conduit 15 for conveying the cotton bolls from the cotton picker/stripper 12 to the continuous round baler 20. An elongated lower cotton boll accommodating outlet slot 68 is formed in the lower side 69 of the conduit 15 towards the downstream end 14 thereof and above the roll gap 25 of the conical bale chamber 22 and the forward portion of the cylindrical bale chamber 24 for accommodating delivery of the cotton bolls 7 from the conduit 15 into the conical and cylindrical bale forming chambers 22, 24 through the roll gap 25.

An upper air venting opening 70 extending along an upper side 72 of the conduit 15 above the outlet slot 68 vents air from the conduit 15 above the outlet slot 68. A screen 74 of suitable mesh size is located in the air venting opening 70 to allow air to escape through the air venting opening 70 but to prevent escape of the cotton bolls 7 therethrough, thereby lowering the air pressure within the conduit 15 adjacent the downstream end 14 thereof to cause the cotton bolls to drop downwardly into the conical bale chamber 22 and the forward portion of the cylindrical bale chamber 24 between the roll gap 25.

A plurality of pivotally mounted baffles 76 located in the conduit 15 adjacent the air venting opening 70 are provided for directing the cotton bolls from the conduit 15 into the conical and cylindrical bale chambers 22 and 24, and for controlling the rate at which air is vented through the air venting opening 70 to in turn control the air pressure towards the downstream end 14 of the conduit 15. The control baffles 76 are adjusted to control the air flow, so that most of the harvested cotton bolls are delivered into the conical bale chamber 22 while allowing a proportion of the harvested cotton bolls to reach the downstream end 14 of the conduit 15 for in turn delivery into the forward portion of the cylindrical bale chamber 24.

In use, with the bale severance mechanism 54 and the bale engaging disc 50 of the tailgate 40 located adjacent the rearward end 30 of the cylindrical bale chamber 24, and with the frustoconical bale rotating rolls 21 and the cylindrical bale rotating rolls 23 rotating in the direction of the arrow A, the cotton harvester 10 is ready for use. The cotton harvester 10 is driven forwardly and the cotton picker/stripper 12 picks and strips the cotton bolls 7 from the standing cotton plant 8. The cotton bolls 7 are delivered by the air flow created by the fan 66 through the conduit 15 and in turn are delivered into the conical bale chamber 22 and the forward portion of the cylindrical bale chamber 24 through the roll gap 25.

With the frustoconical bale rotating rolls 21 rotating, the cotton bolls are rotated in the conical bale chamber 22 to commence formation of the conical bale 33 in the conical bale chamber 22. As the conical bale 33 continues to rotate, and as cotton bolls are continuously delivered into the conical bale chamber 22, the diameter of the conical bale commences to increase, and as the diameter increases, the rotating conical bale is compressed by the rotating frustoconical bale rotating rolls 21. As the compression of the conical bale increases, the conical bale commences to protrude into the cylindrical bale chamber 24, and the laminar layer of cotton bolls is applied to the protruding portion of the rotating bale in the forward portion of the cylindrical bale chamber 24 in order to increase the diameter of the portion of the rotating round bale cylinder 26 protruding into the cylindrical bale chamber 24.

As the cotton bolls are being continuously delivered into the conical bale chamber 22, the rotating conical bale continues to protrude along the cylindrical bale chamber 24 until the distal end 44 of the protruding bale engages the bale engaging disc 50 of the tailgate 40. At that stage, the bale engaging disc 50 rotates with the rotating round bale cylinder 26, and commences to apply pressure to the rotating round bale cylinder 26 to control the density of the rotating round bale cylinder 26. Once the force applied to the bale engaging disc 50 by the protruding rotating round bale cylinder 26 is equal to the force applied to the rotating round bale cylinder 26 by the tailgate 40 through the bale engaging disc 50, the bale engaging disc 50, and in turn the tailgate 40 commence to move with the advancing protruding rotating round bale cylinder 26.

As the protruding rotating round bale cylinder 26 passes the wrapping system 35 adjacent the rearward end 30 of the cylindrical bale chamber 24, the wrapping material from the non-tacky film roll 36 and from the tacky film roll 38 is continuously applied to the outer circumferential surface of the rotating round bale cylinder 26. The wrapped round bale cylinder 26 continues to protrude outwardly rearwardly from the rearward end 30 of the cylindrical bale chamber 24 as illustrated in FIG. 4 against the force applied by the bale engaging disc 50 of the tailgate 40.

When the length of the protruding wrapped rotating round bale cylinder 26 between the bale engaging disc 50 and the bale severance mechanism 54 is of the selected round bale length, the severance mechanism 54 is latched onto the inner telescoping member 47 and the knives 56 are operated by the rams 64 to commence severing of the wrapped rotating round bale cylinder 26 as the severance mechanism 54 moves synchronously with the wrapped rotating round bale cylinder 26 and with the inner telescoping member 47.

On completion of severing of the wrapped rotating round bale cylinder 26, the tailgate 40 is pivoted rearwardly and upwardly from the operative state to the inoperative state by the hydraulic ram (not shown) as illustrated in FIGS. 5 and 6 to allow the severed round bale 16 to drop to the ground.

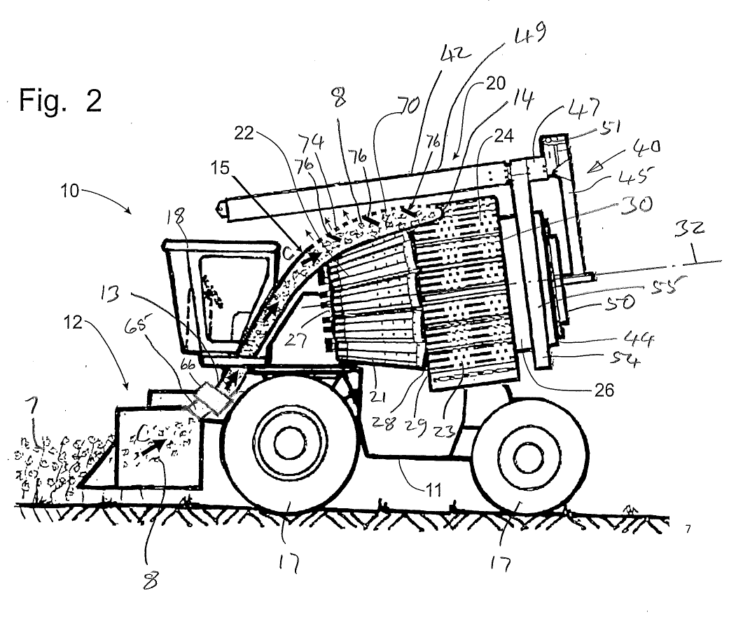

The tailgate 40 is then returned to its operative state illustrated in FIGS. 1 and 2, the severance mechanism 54 is unlatched from the inner telescoping member 47 and the inner telescoping member 47 is withdrawn into the outer telescoping member 49 to return the bale severance mechanism 54 and the bale engaging disc 50 adjacent the rearward end 30 of the cylindrical bale chamber 24 to engage the severed end of the rotating wrapped round bale cylinder 26, which is now the distal end 44 thereof to form the next round bale 16, and so operation of the cotton harvester 10 continues.

It is envisaged that in some embodiments of the invention, the cotton harvester instead of being provided with the continuous round baler 20, the continuous round baler 20 may be replaced by a continuous round baler of the type disclosed in the applicant's U. S. Patent Publication No. 2017/0332556, published on Nov. 23, 2017, now granted as U.S. Pat. No. 10,595,464, on Mar. 31, 2020. The primary difference between the continuous round baler disclosed in U.S. Pat. No. 10,595,464 and the continuous round baler 20, is that the conical bale chamber protrudes the bale into a cylindrical bale chamber that is of the same diameter as the diameter of the adjacent end of the conical bale chamber, and that there would be no deposit of cotton bolls into the cylindrical bale chamber as no laminar layer is needed to increase the diameter of the round bale cylinder being formed. The continuous round baler disclosed in U.S. Pat. No. 10,595,464 has a severance mechanism as described above, and a telescoping tailgate mechanism as described above and produces a round bale cylinder from which appropriately sized round bales are severed and discharged to the ground.

It is also envisaged that instead of providing a single conduit 15 which delivers the cotton bolls into the conical and cylindrical bale chambers 22 and 24 adjacent the upper part of the conical and cylindrical bale chambers 22 and 24, a pair of conduits may be provided for conveying the cotton bolls from the cotton picker/stripper 12 to the conical and cylindrical bale chambers 22 and 24. In which case, it is envisaged that the conduits would be arranged on respective opposite sides of the conical and cylindrical bale chambers 22 and 24, and would deliver the cotton bolls into the conical and cylindrical bale chambers 22 and 24 through roll gaps formed between the bale rotating rolls on the respective opposite sides of the conical and cylindrical bale chambers 22 and 24.

While the tailgate has been described as carrying a rotatably mounted bale engaging disc, while it is advantageous that the bale engaging disc should be rotatably mounted on the tailgate, it is not essential that the disc be rotatably mounted on the tailgate.

Any suitable means for latching the bale severance mechanism 54 to the inner telescoping member may be provided. It is envisaged in some embodiments of the invention that a friction grip arrangement may be provided in the bale severance mechanism 54 which may be activated by any suitable activating means, for example, a hydraulic or pneumatic ram to engage the inner telescoping member with a friction grip for latching the bale severance mechanism to the inner telescoping member. The latching mechanism as already described would be operated when the length of the wrapped rotating round bale cylinder 26 between the bale engaging disc 50 and the bale severance mechanism 54 is equal to the length of the round bale to be severed from the wrapped rotating round bale cylinder 26. It is also envisaged that the length of the round bale to be severed from the wrapped rotating round bale cylinder 26 would be selectable.

While a specific telescoping mounting has been described for telescopingly mounting the tailgate to the frame of the cotton harvester, any other suitable telescoping mountings may be provided.

It will also be appreciated that any suitable urging means for urging the inner telescoping member into the outer telescoping member in order to apply pressure to the wrapped rotating round bale cylinder through the tailgate in order to control the density of the wrapped rotating round bale cylinder may be provided.

It will be understood that changes in the details, materials, steps and arrangements of parts which have been described and illustrated to explain the nature of the invention will occur to and may be made by those skilled in the art upon a reading of this disclosure within the principles and scope of the invention. The foregoing description illustrates the preferred embodiment of the invention; however, concepts, as based upon the description, may be employed in other embodiments without departing from the scope of the invention.

As well as controlling the density of the rotating round bale cylinder 26 protruding from the rearward end of the cylindrical bale chamber by the tailgate, it is envisaged that the density of the protruding rotating round bale cylinder may be controlled and set by the tapering angle of the frustoconical bale rotating rolls of the conical bale chamber. By reducing the tapering angle of the frustoconical bale rotating rolls, the density of the rotating round bale cylinder protruding from the rearward end of the cylindrical bale chamber is increased.

1. A cotton harvester for harvesting cotton bolls from standing cotton plants, comprising:
a frame;
a conduit cooperable with a fan to provide an air flow through said conduit to convey harvested cotton bolls rearwardly; and
a continuous round baler supported on said frame and operable to receive harvested cotton bolls from said conduit and to continuously form a round bale cylinder protruding rearwardly from said round baler, said continuous round baler including a severance mechanism to sever a round bale of selected length from said protruding round bale cylinder for discharge to the ground.

2. The cotton harvester of claim 1 wherein said continuous round baler includes a conical bale chamber and a rearwardly adjacent cylindrical bale chamber.

3. The cotton harvester of claim 2 wherein the conical bale chamber and the cylindrical bale chamber are axially aligned.

4. The cotton harvester of claim 2 wherein the conical bale chamber and the cylindrical bale chamber define a common central axis, the common central axis defined by the conical bale chamber and the cylindrical bale chamber lying in a plane substantially parallel to the normal forward direction of movement of the harvester.

5. The cotton harvester of claim 2 wherein the conical bale chamber is defined by a plurality of circumferentially arranged frustoconical bale rotating rolls, and the cylindrical bale chamber is defined by a plurality of circumferentially arranged parallel cylindrical bale rotating rolls.

6. The cotton harvester of claim 5 wherein said conduit delivers said cotton bolls into said continuous round baler through a roll gap formed between the bale rotating rolls.

7. The cotton harvester of claim 2 wherein said conical bale chamber forms a conical bale that protrudes into said cylindrical bale chamber.

8. The cotton harvester of claim 7 wherein said conduit delivers cotton bolls to both said conical bale chamber having a first maximum diameter and said cylindrical bale chamber having a second diameter greater than said first maximum diameter, said conical bale chamber protruding said conical bale rearwardly into said cylindrical bale chamber where said cotton bolls delivered to said cylindrical bale chamber add a laminar layer onto said conical bale to increase the diameter of said bale to said second diameter.

9. The cotton harvester of claim 8 wherein the cotton bolls delivered to said cylindrical bale chamber are delivered to the cylindrical bale chamber towards the forward end of the cylindrical bale chamber.

10. The cotton harvester of claim 2 further comprising a telescoping tailgate engageable with a distal end of said round bale cylinder protruding from said cylindrical bale chamber.

11. The cotton harvester of claim 10 wherein the telescoping tailgate is moveable with the distal end of the round bale cylinder to control and/or adjust the density of the round bale cylinder.

12. The cotton harvester of claim 10 wherein said telescoping tailgate disengages from said round bale after said round bale is severed from said round bale cylinder, the tailgate being retracted and repositioned to engage a new distal end of said round bale cylinder protruding from said cylindrical bale chamber in response to severing of the round bale from the round bale cylinder.

13. The cotton harvester of claim 10 wherein the severance mechanism is latched relative to the telescoping tailgate in response to the round bale cylinder protruding from the cylindrical bale chamber being of length substantially equal to the selected length of the round bale to move synchronously with the tailgate during severing of the round bale cylinder.

14. The cotton harvester of claim 1 further comprising a cotton picker/stripper supported from a forward position on said frame to harvest cotton bolls from standing cotton plants, said conduit delivering said cotton bolls from said cotton picker/stripper to said continuous round baler.

15. The cotton harvester of claim 2 wherein said conduit includes flow control baffles to deflect cotton bolls into the conical and cylindrical bale chambers and screening to allow air to escape said conduit to lower pressure and assist the direction of the cotton bolls into the conical and cylindrical bale chambers.

16. The cotton harvester of claim 2 further comprising a wrapping system positioned at a rearward portion of said cylindrical bale chamber to place a wrapping material on an outer circumferential surface of said round bale cylinder.

17. The cotton harvester of claim 16 wherein said wrapping system applies a wrapping material that presents a non-tacky surface against said outer circumferential surface of said round bale cylinder and a tacky surface facing outwardly from said round bale cylinder so that progressive overlapping turns of said wrapping material stick together as the wrapping material is applied to the continuously protruding round bale cylinder.

18. A combination cotton harvester and round baler for harvesting cotton bolls from standing cotton plants and forming round bales of cotton bolls, comprising:
a frame supporting a cotton picker/stripper for removing cotton bolls from standing cotton plants;
a conduit operatively interconnecting said picker/stripper and being co-operable with a fan to provide an air flow through said conduit to convey harvested cotton bolls rearwardly from said picker/stripper; and
a continuous round baler supported on said frame and operable to receive harvested cotton bolls from said conduit and to continuously form a round bale cylinder protruding rearwardly from said round baler, said continuous round baler including a severance mechanism to sever a round bale of selected length from said protruding round bale cylinder for discharge to the ground, said continuous round baler also including a conical bale chamber formed by a plurality of conical bale rotating rolls terminating at a cylindrical bale chamber to form said round bale cylinder axially protruding rearwardly from said cylindrical bale chamber.

19. The combination cotton harvester and round baler of claim 18 wherein said continuous round baler includes a tailgate engaged with a rearward end of said round bale cylinder protruding rearwardly, said tailgate helping to control density in said round bale cylinder.

20. The combination cotton harvester and round baler of claim 19 wherein each said conical bale rotating roll includes a taper having a predetermined slope value, said predetermined slope value and said tailgate controlling density of said round bale cylinder.

21. A method for harvesting cotton bolls from standing cotton plants, the method comprising:
conveying cotton bolls harvested from the standing plants through a rearwardly extending conduit in an air flow through the conduit to a continuous round baler,
continuously forming a round bale cylinder in the continuous round baler and protruding the round bale cylinder rearwardly from the continuous round baler, and
severing a round bale of selected length from the protruding round bale cylinder.

22. The method of claim 21 wherein the continuous round baler comprises a conical bale chamber and a rearwardly adjacent cylindrical bale chamber communicating with the conical bale chamber, and the method further comprises conveying the cotton bolls into the conical bale chamber, and forming a conical bale of the cotton bolls in the conical bale chamber, and protruding the conical bale into the cylindrical bale chamber to form a round bale cylinder.

23. The method of claim 22 wherein cotton bolls are delivered into the cylindrical bale chamber towards a forward end thereof to form a laminar layer extending circumferentially around the round bale cylinder in the cylindrical bale chamber.
